(19) United States
(12) Patent Application Publication
(10) Pub. No.: US 2024/0303726 A1
(43) Pub. Date: Sep. 12, 2024

(54) AN APPARATUS, METHOD AND COMPUTER PROGRAM PRODUCT FOR IDENTIFYING A VALIDATION CHECK FOR A SET OF NUMBERS

(71) Applicant: VOCALINK LIMITED, London (GB)

(72) Inventors: Jignesh Zinabhai LAD, Sutton (GB); Clifford Norman RUSSELL, Camberley (GB)

(21) Appl. No.: 18/276,439

(22) PCT Filed: Nov. 2, 2021
(86) PCT No.: PCT/EP2021/084065

§ 371 Date: Aug. 8, 2023

(30) Foreign Application Priority Data
Feb. 24, 2021 (GB) 2102599.4

(51) Int. Cl. G06F 16/23

(52) U.S. Cl. CPC G06F 16/2365

(57) ABSTRACT

An apparatus, method and computer program product for identifying a validation check for a set of numbers is provided. The apparatus comprises circuitry configured to: obtain first data comprising a set of unique numbers for which a validation check is unknown; determine a plurality of candidate validation functions to apply to the first data; determine a plurality of candidate weightings to apply to the first data; for each of the plurality of candidate validation functions and each of the plurality of candidate weightings: apply the candidate validation function to the first data; and determine, for each number of the set of unique numbers, whether the candidate validation function confirms that the number is valid; and when the number of confirmations for a candidate weighting and a candidate validation function is above a predetermined threshold, identify the candidate validation function and candidate weighting as the validation check for the first data.

### BACKGROUND

### Field of the Disclosure

The present invention relates to an apparatus, method and computer program product for identifying a validation check for a set of numbers.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

Modern computational systems and services rely on the transfer of data. Inaccuracies in the data which is being transferred can have significant impact on the operation of these systems and services. Inaccuracies in the data may occur in situations whereby an error has been made when entering data into the computational system or when the data has become corrupted, for example. These inaccuracies in data can have a significant impact on the computational system, requiring complex remedial actions to rectify. Accordingly, there is a desire to reduce the impact of inaccuracies in data.

In order to reduce the impact of such inaccuracies, computational systems and services may apply techniques for checking or validating the data. These techniques may include conventional processes such as the use of check digits within the data and/or the use of validation checks such as modulus checks or the like. Validation functions (such as modulus/modulo functions), used as part of these validation checks, take certain data as input, and output, for that data, an indication as to whether that data is valid. These techniques can be used to reduce the impact of inaccuracies in data as they can identify data inaccuracies (such as invalid data) when the inaccuracy occurs.

In certain situations, information regarding the validation function or validation check which should be used in order to validate a number may have become lost or corrupted, or for novel exogenous reasons, need to be discovered due to a new situation. For example, financial institutions use validation checks to validate bank account numbers. However, certain actions such as mergers of financial institutions, implementation of new computational systems or the like may lead to information regarding validation checks becoming no longer valid for the dataset it is supposed to protect. This prevents validation checks being performed on the data, which can increase both the instances of data inaccuracies and the impact each of those individual inaccuracies have on the computational systems. Invalidity of data checks can also result in valid data being falsely rejected. In the example of financial institutions, this may cause payers, payees and their respective banks significant concomitant losses and disruption.

Accordingly, when information regarding a validation check becomes unavailable (such as when information regarding the validation check becoming lost or corrupted), the data associated with that validation check may become unusable. In the example of financial institutions, it may therefore be necessary to close any bank account for which validation checks can no longer be performed, leading to significant disruption for both the financial institutions and their customers. On the other hand, maintaining the account, for which a validation check is unavailable, risks inaccuracies arising in the data which could cause significant disruption and computational burden on the system or financial loss. Moreover, generating and establishing new bank accounts, with associated validation information, to replace those accounts which have been closed can also be very disruptive and computationally expensive.

It is an aim of the present disclosure to provide a technical solution which can address these issues.

### SUMMARY

According to a first aspect of the invention, there is an apparatus for identifying a validation check for a set of numbers the apparatus comprising circuitry configured to: obtain first data, the first data comprising a set of unique numbers for which a validation check is unknown, each number of the set of unique numbers being a multi-digit number having a predetermined length; determine a plurality of candidate validation functions to apply to the first data, each of the plurality of candidate validation functions being configured to take a number and weighting as input to the function and return, on the basis of the input, confirmation of whether the number is valid; determine a plurality of candidate weightings to apply to the first data; and for each of the plurality candidate validation functions and each of the plurality candidate weightings: apply the candidate validation function to first data using the set of unique numbers and the candidate weighting as input; and determine, for each number of the set of unique numbers, whether the candidate validation function confirms that the number is valid using the candidate weighting; and when, for the first data, the number of confirmations for a candidate weighting and a candidate validation function is above a predetermined threshold, identify the candidate validation function and the candidate weighting as the validation check for the first data.

According to a second aspect of the invention, there is a method of identifying a validation check for a set of numbers the method comprising the steps of: obtaining first data, the first data comprising a set of unique numbers for which a validation check is unknown, each number of the set of unique numbers being a multi-digit number having a predetermined length; determining a plurality of candidate validation functions to apply to the first data, each of the plurality of candidate validation functions being configured to take a number and weighting as input to the function and return, on the basis of the input, confirmation of whether the number is valid; determining a plurality of candidate weightings to apply to the first data; and for each of the plurality candidate validation functions and each of the plurality candidate weightings: applying the candidate validation function to first data using the set of unique numbers and the candidate weighting as input; and determining, for each number of the set of unique numbers, whether the candidate validation function confirms that the number is valid using the candidate weighting; and when, for the first data, the number of confirmations for a candidate weighting and a candidate validation function is above a predetermined threshold, identifying the candidate validation function and the candidate weighting as the validation check for the first data.

According to a third aspect of the invention, there is a computer program product comprising instructions which, when the instructions are implemented by a computer, cause the computer to perform a method of identifying a validation check for a set of numbers, the method comprising the steps of obtaining first data, the first data comprising a set of unique numbers for which a validation check is unknown, each number of the set of unique numbers being a multi-digit number having a predetermined length; determining a plurality of candidate validation functions to apply to the first data, each of the plurality of candidate validation functions being configured to take a number and weighting as input to the function and return, on the basis of the input, confirmation of whether the number is valid; determining a plurality of candidate weightings to apply to the first data; and for each of the plurality candidate validation functions and each of the plurality candidate weightings: applying the candidate validation function to first data using the set of unique numbers and the candidate weighting as input; and determining, for each number of the set of unique numbers, whether the candidate validation function confirms that the number is valid using the candidate weighting; and when, for the first data, the number of confirmations for a candidate weighting and a candidate validation function is above a predetermined threshold, identifying the candidate validation function and the candidate weighting as the validation check for the first data.

According to aspects of the present disclosure, the instances of data inaccuracies propagating through a computational system, and the impact those data inaccuracies have upon the computational systems, can be reduced, even in situations where information regarding the validation check corresponding to a number, or set of numbers, is not available. In fact, aspects of the present disclosure provide a particularly computationally efficient and reliable mechanism for identifying a validation check for a set of numbers for which a validation check is unknown or has some failures.

The present disclosure is not particularly limited to the advantageous technical effects described above. There may be others as will become apparent to the skilled person when reading the disclosure.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an apparatus in accordance with embodiments of the disclosure;

FIG. 2 illustrates an example validation checking process in accordance with embodiments of the disclosure;

FIG. 3 illustrates a configuration of circuitry of the apparatus for identifying a validation check for a set of numbers according to embodiments of the disclosure;

FIG. 4 illustrates a matrix of candidate validation functions and candidate validation weightings in accordance with embodiments of the disclosure;

FIG. 5 illustrates an example number and candidate weighting in accordance with embodiments of the disclosure;

FIG. 6 illustrates an application of a candidate validation function in accordance with embodiments of the disclosure;

FIG. 7 illustrates an output of the apparatus for identifying a validation check for a set of numbers in accordance with embodiments of the disclosure;

FIG. 8 illustrates a method of identifying a validation check for a set of numbers according to embodiments of the disclosure.

### DESCRIPTION OF THE EMBODIMENTS

Referring now to the drawings, wherein like reference numerals designate identical or corresponding parts throughout the several views.

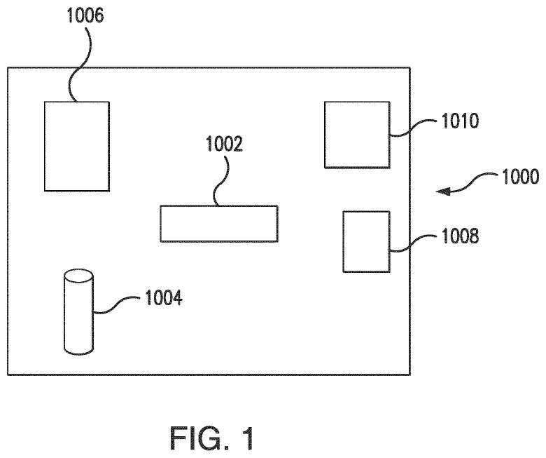

Referring to FIG. 1, an apparatus 1000 according to embodiments of the disclosure is shown.

Typically, an apparatus 1000 according to embodiments of the disclosure is a computer device such as a personal computer or a terminal connected to a server. Indeed, in embodiments, the apparatus may also be a server. The apparatus 1000 is controlled using a microprocessor or other processing circuitry 1002. In some examples, the apparatus 1000 may be a portable computing device such as a mobile phone, laptop computer or tablet computing device; or a specialised high performance Graphical Processing Unit (GPU) parallel computing device or the like.

The processing circuitry 1002 may be a microprocessor carrying out computer instructions or may be an Application Specific Integrated Circuit. The computer instructions are stored on storage medium 1004 which maybe a magnetically readable medium, optically readable medium or solid state type circuitry.

The storage medium 1004 may be integrated into the apparatus 1000 or may be separate to the apparatus 1000 and connected thereto using either a wired or wireless connection. The computer instructions may be embodied as computer software that contains computer readable code which, when loaded onto the processor circuitry 1002, configures the processor circuitry 1002 to perform a method according to embodiments of the disclosure.

Additionally, an optional user input device 1006 is shown connected to the processing circuitry 1002. The user input device 1006 may be a touch screen or may be a mouse or stylist type input device. The user input device 1006 may also be a keyboard or any combination of these devices, or, in fact, any other device suitable for communicating instructions from a user to apparatus 1000.

A network connection 1008 may optionally be coupled to the processor circuitry 1002. The network connection 1008 may be a connection to a Local Area Network or a Wide Area Network such as the Internet or a Virtual Private Network or the like. The network connection 1008 may be connected to a server allowing the processor circuitry 1002 to communicate with another apparatus in order to obtain or provide relevant data. The network connection 1002 may be behind a firewall or some other form of network security. Furthermore, network connection 1008 may include mobile connectivity. Any suitable method of communication between a plurality of devices can be used in accordance with embodiments of the disclosure as required. The present disclosure is not particularly limited in this respect.

Additionally, shown coupled to the processing circuitry 1002, is a display device 1010. The display device 1010, although shown integrated into the apparatus 1000, may additionally be separate to the apparatus 1000 and may be a monitor or some kind of device allowing the user to visualize the operation of the system. In addition, the display device 1010 may be a printer, projector or some other device allowing relevant information generated by the apparatus 1000 to be viewed by the user or by a third party.

### <Validation Checking>

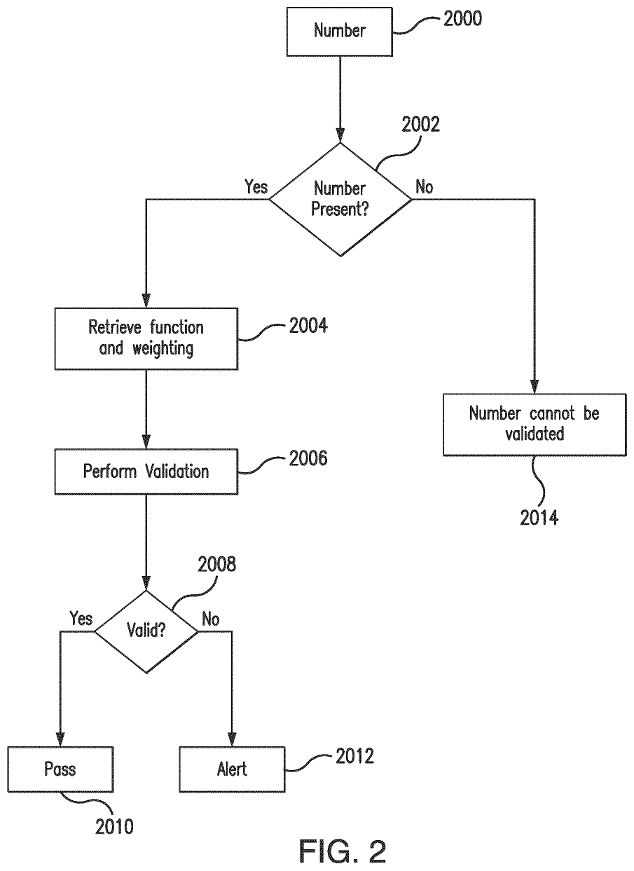

Referring to FIG. 2, an example validation checking process in accordance with embodiments of the disclosure is illustrated. This process may be performed by a financial institution, or other actor in a business transaction, to validate numbers such as a bank account number.

In this example validation checking process, a number for which validation checks are to be performed is obtained in step 2000. The number is a multi-digit number having a predetermined length (such as an eight digit bank account number and/or a six digit sort code). In the event that a set of numbers is received, it may be the situation that the set is comprised of unique numbers. That is, each number within the set of numbers may appear within the list only once, such that it is a unique number of that list.

In step 2002, the number (or an individual number of the set of numbers which has been received) is selected for validation. Before a validation check can be performed, however, it is necessary to identify whether the number is a number for which validation checks are available. As such, in step 2002, a determination is made in order to identify whether or not information regarding an appropriate validation check is available for the number. In some examples, this may include preforming a look-up to identify whether or not the number is present within a database of validation information. Considering the example of banking information, a search may be performed for the six digit sort code within a database which stores sort codes against corresponding validation checks. The validation check corresponding to the sort code can then be applied to the account number. In other examples, the information regarding the validation check may be provided with the number itself.

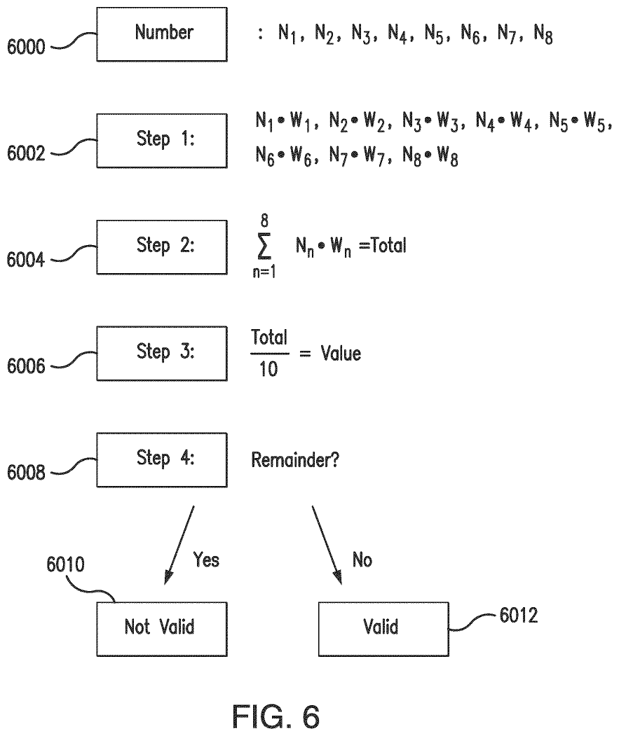

If information regarding the validation check is located (that is, if the number is present) then the process proceeds to step 2004. In step 2004, the process then includes retrieving the validation check from the database for use in validating the number. The validation check is comprised of a validation function and associated set of weightings. It will be appreciated that a validation function is a function configured to take a number and corresponding weighting as input, and return, based on the input, confirmation as to whether or not the number is valid. Such validation functions include validation functions such as modulus/modulo functions or the like. Examples of such validation functions will be described in more detail with reference to FIG. 6 of the present disclosure. However, it will be appreciated that the weighting and validation function retrieved from the database are such that if the weighting and validation function are applied to the number, it can be determined whether or not the number is valid.

Once this information has been retrieved from the database, it is applied to the number in order to determine whether the number is valid. This is performed in step 2006.

Once the validation has been performed, the output of the validation number is assessed, in step 2008, in order to confirm whether or not the number is valid. The type of check which is performed on the output of the function will depend upon the function which has been used to validate the number. However, assuming that the number is valid (and contains no inaccuracies) the output of the validation function will satisfy the check in step 2008. Accordingly, in step 2010, the number will be identified as valid. Alternatively, if the number is not valid (a data entry error being made when the data was input, for example) the output of the validation function will not satisfy the check performed in step 2008. Accordingly, in step 2012, the data will be identified as invalid. In certain situations, an alert (or flag) may be raised regarding the number indicating that the number is invalid. That is, action can be taken in order to rectify or remove the invalid information.

Identification of inaccuracies in the data in this manner reduces the impact which such inaccuracies have upon computational systems because the invalid data can be removed or rectified before it propagates through the system.

Returning now to step 2002, the situation whereby the number to be validated is not present within the database is considered. If the number is not present within the database then information regarding the validation check to be applied to the number cannot be obtained. If the incorrect validation function and/or incorrect weightings for that function are used, the number may be identified as invalid even if no such data inaccuracies are present within the number (i.e. even if the number is valid). Accordingly, if the correct validation function and/or validation number for the number cannot be identified the validation check cannot be performed on the number. Therefore, in this case, the process proceeds directly to step 2014.

Consequentially, if the validation check for the number cannot be performed, it is not possible to check whether inaccuracies are present within the data. Accordingly, inaccuracies within the data may go undetected. This can increase both the instances of data inaccuracies and the impact those inaccuracies have on the computational systems. In certain situations, it may therefore be determined that since validation checks cannot be performed on the number, the number will have to be removed from the set of numbers. However, this has a direct impact on the objects and data associated with that number. Consider again the situation where the numbers obtained in step 2000 relate to banking information. Inability to use the banking information will result in the account associated with that banking information having to be closed down, leading to significant disruption. Moreover, generating and establishing new bank accounts, with associated validation information, to replace those accounts which have been closed can be very computationally expensive.

Accordingly, there is a need for a technical solution to address the situation of how to validate information when the validation checks for a number, or a set of numbers, is unknown.

An apparatus for identifying a validation check for a set of numbers is provided in accordance with embodiments of the disclosure.

### <Apparatus>

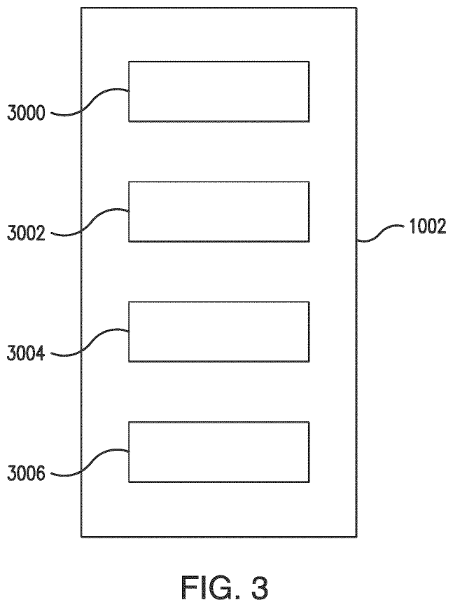

Referring to FIG. 3 of the present disclosure, an example configuration of circuitry of the apparatus for identifying a validation check for a set of numbers according to embodiments of the disclosure is illustrated. The circuitry 1002 of apparatus 1000 may be specifically configured to comprise an obtaining unit 3000, a determination unit 3002, an application unit 3004 and an identification unit 3006.

According to embodiments of the disclosure, the obtaining unit 3000 may be configured to obtain first data, the first data comprising a set of unique numbers for which a validation check is unknown, each number of the set of unique numbers being a multi-digit number having a predetermined length. The determination unit 3002 may be configured to determine a plurality of candidate validation functions to apply to the first data, each of the plurality of candidate validation functions being configured to take a number and weighting as input to the function and return, on the basis of the input, confirmation of whether the number is valid. Furthermore, the determination unit 3002 may also be configured to determine a plurality of candidate weightings to apply to the first data.

The application unit 3004 may be configured such that for each of the plurality candidate validation functions and each of the plurality candidate weightings the application unit 3004 applies the candidate validation function to first data using the set of unique numbers and the candidate weighting as input.

Moreover, the determination unit 3002 may further be configured, for each number of the set of unique numbers, to determine whether the candidate validation function confirms that the number is valid using the candidate weighting.

When, for the first data, the number of confirmations for a candidate weighting and a candidate validation function is above a predetermined threshold, the identification unit 3006 may be configured to identify the candidate validation function and the candidate weighting as the validation check for the first data.

In this manner, the validation check for a set of numbers can be efficiently and reliably determined by apparatus 1000. As such, even in the event where the information regarding the validation check to be performed on a number is unavailable or unknown (being lost or corrupted for example) it is possible to identify the validation check which should be performed on the number. This enables validation checks to be performed on the number in future data processing, using the validation check which has been identified, such that future inaccuracies (such as future data entry errors concerning that set of numbers) can be identified. Impact of inaccuracies in data for which validation checks are not available on the computational systems can therefore be reduced.

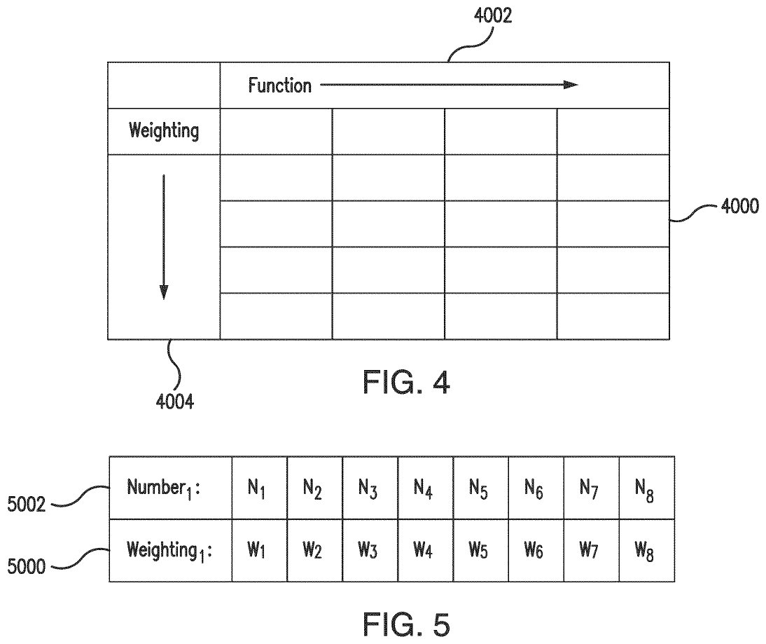

Further details regarding the use of apparatus 1000 for the identification of a validation check for a set of numbers will now be described with reference to FIGS. 4 to 7 of the present disclosure.

### <Set of Numbers>

As described with reference to FIG. 3 of the present disclosure, the obtaining unit 3000 may be configured to obtain may be configured to obtain first data, the first data comprising a set of unique numbers for which a validation check is unknown, each number of the set of unique numbers being a multi-digit number having a predetermined length. Of course, it is known (or assumed) that these numbers are valid numbers (that is, no inaccuracies in the data have arisen at present). In other words, within the present disclosure, a valid number is a number which has been directly generated by a validation function and validation weightings (and for which no inaccuracies have arisen post generation). However, it is not known which validation check should be performed on the data. As such, it will not be possible to identify future inaccuracies in the data using a validation check unless the correct validation check for the data can be determined.

The mechanism by which the obtaining unit 3000 obtains this first data is not particularly limited in the present disclosure. In some examples, the first data may be stored on a storage device (such as storage device 1004). The first data may then be retrieved from the storage by the obtaining unit 3000. In fact, as noted with reference to FIG. 1 of the present disclosure, the storage device may be either internal or external to apparatus 1000. For example, if external to apparatus 1000, the storage device may be part of an external server storing the first data prior to processing.

Alternatively, the obtaining unit 3000 may obtain the first data from an external device using communication circuitry (such as network connection 1008). That is, any wired or wireless communication means may be used in order that the obtaining unit can receive the first data. The first data may be received over a local network, for example.

In some examples, the obtaining unit may load the first set of data into working memory (such as Random Access Memory) in order that the first data can be readily accessed by the other units of apparatus 1000. This may further improve the efficiency of operation.

Now, as previously described (with reference to FIG. 2 of the present disclosure) it will be appreciated that the first data is data comprising a set of unique numbers for which a validation check is unknown (e.g. numbers which were processed in step 2014 of FIG. 2). Each number within the set of numbers is unique because it appears within the set of numbers only once within that data set. Moreover, there is a one to one relationship between the number and the object indicated by that number (such as an account). Furthermore, in accordance with the present disclosure, the numbers may comprise a check digit used to check for errors or inaccuracies (such as a mistake when the data has been entered into the system). That is, the numbers of the first data have been generated while being in compliance with a data validation mechanism/standard, such that a validation check can be performed on the data. However, the validation check which should be used with these numbers is unknown (because information regarding the validation check is unavailable). This may be because the information regarding the validation check has been lost or become corrupted after the number has been generated. Accordingly, as described with reference to step 2002 and 2014 of FIG. 2 of the present disclosure, even though the set of numbers of the first data have been generated in compliance with a data validation mechanism/standard, it is no longer possible to perform data validation checks on the first data because the information regarding the data validation check is unavailable (or the premise upon which the banks used it was flawed).

Furthermore, each number of the set of unique numbers is a multi-digit number having a predetermined length. Consider the example where the set of unique numbers is a set of account numbers. Each account number has a predetermined length (such as an eight digit account number in the United Kingdom or an International Bank Account Number (IBAN numbers are of fixed length within a specific country—ranging from 15 characters in Norway to 32 in St Lucia, for example)). In the situation whereby the numbers do not have a predetermined length, the numbers may be standardised to a predetermined length by the obtaining unit 3000 (such as the conversion of a seven digit account number to an equivalent eight digit account number). The manner of standardising the set of unique numbers such that the first data comprises a set of multi-digit numbers having a predetermined length will depend upon the type and form of the numbers and is, as such, not particularly limited in the present disclosure.

While the first data has been described as comprising a set of numbers such as bank account numbers, it will be appreciated that the present disclosure is not particularly limited in this respect. For example, the set of numbers may, optionally, further include the corresponding sort code of the account numbers. Alternatively, the set of numbers may be a set of numbers such as international standard book numbers, patent application numbers, numbers of registered users of a health service or the like. In fact, the numbers may be any other type of multi-digit number having a predetermined length for which the validation check is unknown.

### <Candidate Validation Functions and Weightings>

As described with reference to FIG. 3 of the present disclosure, once the first data has been obtained by the obtaining unit 3000, the determining unit 3002 may determine both a plurality of candidate validation functions and a plurality of candidate weightings to apply to the first data.

In some examples, the determining unit 3002 is configured to determine a plurality of candidate validation functions from a list of available validation functions. The list of available validation functions may vary depending upon the form and type of the first data itself (or, in some examples, according to the preference of the bank issuing such numbers). That is, certain validation functions may be known to be applicable only to a certain type of data (such as bank account numbers or the like). The list of available validation functions for each type of data may be held in the storage of apparatus 1000 for example. Alternatively, the list of available validation functions for a given type and/or form of number may be publically available from an external server or the like.

FIG. 4 of the present disclosure illustrates an example table 4000 which may be used in order to store information regarding the validation functions which are available. In this example table 4000, each column 4002 of the table 4000 is used to store information regarding a certain validation function which can be used to validate data.

In some examples, the plurality of candidate validations functions may include at least a standard modulus function and a double alternative modulus function. Of course, it will be appreciated that the present disclosure is not limited specifically to types of modulus functions such as these. Any conventional validation functions which are applicable to the certain type of data for which the validation check is unknown may be considered as candidate validation functions in accordance with the present disclosure. A specific example of a validation function will be described in more detail with reference to FIG. 6 of the present disclosure.

Now, these validation functions are referred to as candidate validation functions because they are validation functions which may be the validation function which can be used in order to validate the first data (being those types of validation functions which are applicable to the specific type of first data which has been obtained). However, it will be appreciated that, at this stage, the actual validation function from amongst the candidate validation functions which is the validation function which can be used in order to validate the first data is unknown. That is, all of the candidate validation functions are potential validation functions which may be used to validate the data. However, only the validation function which is the validation function with which the first data has been generated will be the validation function which can be used as part of the validation check for the first data.

In certain examples, the determining unit 3002 may limit the candidate validation functions to only the most likely validation functions for a given set of numbers (e.g. if it is known that 90% of account numbers use a certain subset of validation functions). This selection of a subset of the most likely validation functions improves the efficiency of the apparatus 1000. However, in other examples, the determination unit 3002 may select all of the validation functions which are applicable to the type of the first data. In fact, in certain examples, a subset of the candidate validation functions may be selected for an initial attempt at identification of the validation check, with the subset of candidate validation functions being expanded to all available validation functions only if a validation check for the first data is not found using the subset of candidate validation functions. This may further improve the efficiency of apparatus 1000 when identifying the validation check for the first set of numbers.

In this manner, the determination unit determines the candidate validation functions to apply to the first data (being those validation functions which are applicable to the type of numbers contained within the first data).

The determination unit 3002 is further configured to determine the candidate weightings to apply to the first data. These weightings are the weightings which should be used as input to the candidate validation functions, with the first data, in order to check with the data is valid. That is, the weightings and the validation function together form the validation check for the first data. Only the correct combination of weightings and validation function will result in the valid number being confirmed as valid by the validation check (i.e. only the correct combination of weightings and validation function form the correct validation check for the first data).

The plurality of weightings which can be applied to the data may also be stored in example storage table 4000. In some examples, each candidate weighting of the candidate weightings may be a multi-digit number of the same predetermined length as the numbers within the first data. This is illustrated in FIG. 5 of the present disclosure.

In FIG. 5, a weighting 5000 (being, for example, the first candidate weighting of the plurality of candidate weightings) is shown next to a number 5002 (being, for example, the first number in the set of numbers of the first data). In this example, the weighting 5000 and the number 5002 are both multi-digit numbers of the same predetermined length. That is, each of the number 5002 and the weighting 5000 comprise eight digits (namely N1 to N8 and W1 to W8). As such, each digit in the weighting 5000 describes the weighting which should be applied to the corresponding digit within the number 5002 when applying a validation function to that number 5002. For example, a weighting of W1 is applied to N1, a weighting of W2 is applied to N2 and the like. Each candidate validation function takes both the weighting 5000 and the number 5002 as input; only the correct validation function with the correct weighting 5000 will produce confirmation that the first number 5002 is valid.

Accordingly, each row 4004 of the example table 4000, for each column 4002, stores a weighting 5000 being a multi-digit number of the predetermined length of the numbers of the first data (thus describing the weighting to be applied to each digit of the number when applying each candidate validation function).

Now, it will be appreciated that the weightings 5000 stored in the columns of example table 4000 are candidate weightings to be applied to the first data using the candidate validation functions. That is, because the validation check for the first data is unknown, the actual weighting which has been applied in order to generate the first data (in addition to the actual validation function) is unknown. As such, the candidate weightings are merely potential weightings (one of which, in combination with the correct validation function, will form the correct validation check for the first data).

The actual range of candidate weightings 5000 which are determined by the determining unit 3002 will vary in accordance with the first data which has been obtained. In a certain example, each digit of each candidate weighting may be a number between 0 and 9. In this example, the candidate weightings will range from 00000000 to 99999999 for an eight digit number (that is, where the predetermined length of the numbers of the first data are eight digits in length). Each of these weightings would then be a candidate weighting for the first data.

In other examples, the determination unit 3002 may determine the plurality of candidate weightings to apply to the first data by setting a range of candidate weightings between a predetermined start and end number. As an example, the determination unit 3002 may set the range of the candidate weightings from 10000000 to 20000000 for an eight digit number (that is, where the predetermined length of the numbers of the first data are eight digits in length). The determination unit 3002 may restrict the range of the candidate weightings in this manner when it is known that, for a certain type of number, only weightings within that range are used to generate numbers (such as the first data). Alternatively, the determination unit 3002 may restrict the range of the candidate weightings in this manner when certain additional information indicates that the actual weightings are likely to be within this range. Only in the event that it was later determined that the actual weighting was not within that range would the range of candidate weightings be expanded. This reduces the number of candidate weightings which are determined, which further improves the efficiency of the apparatus 1000 when applying those candidate weightings to the first data.

Alternatively or in addition, in certain examples, the determination unit may be configured to vary only digits in a predetermined location within each multi-digit candidate weighting when determining candidate weightings to apply to the first data. That is, for certain types of data it may be known that a certain value of the weighting is used for a certain digit within the number (i.e. that certain value is a fixed value which does not vary). Therefore, in this situation, only the weightings to apply to the other digits within the number need to be determined. Consider the example of an eight digit number; here it may be known that the third, fourth, seventh and eighth digits have no weighting (or a fixed value of weighting which does not change). In this situation, a plurality of candidate weightings only for the first, second, fifth and sixth digits within the number need to be determined. The plurality of candidate weightings for these digits of the number may then vary between 0 and 9. However, the weightings for the other digits within the number remain fixed (and do not change). This may significantly reduce the number of candidate weightings which are determined by the determining unit 3002. Therefore, the efficiency of apparatus 1000 is further improved.

It will be appreciated that the present disclosure is not particularly limited to these examples. Rather, any appropriate method of determining the candidate validation functions and candidate weightings may be used depending on the form and type of the first data.

### <Application to a Set of Numbers>

As described with reference to FIG. 3 of the present disclosure, once the first data has been obtained, and once the candidate validation functions and candidate weightings have been determined, the application unit 3004 is configured to apply, for each of the plurality candidate validation functions and each of the plurality candidate weightings, the candidate validation function to first data using the set of unique numbers and the candidate weighting as input. That is, each candidate validation function and each candidate weighting is applied to each number of the set of unique numbers of the first data in turn by the application unit 3004.

FIG. 6 shows an example application of a candidate validation function and a candidate weighting (together forming a validation check) to a number from the set of unique numbers. In this example, the candidate validation function is a modulus 10 validation function; the weighting is weighting 5000 described with reference to FIG. 5 of the present disclosure and the number is number 5002 described with reference to FIG. 5 of the present disclosure.

The steps performed by the application unit 3004 in this example begin with step 6000, where an individual number of the unique set of numbers of the first data is selected. In this specific example, this number is an eight digit number comprising the digits N1 to N8.

Then, in step 6002, the current candidate weighing of the plurality of candidate weightings is applied to the number. In this example, for the modulus 10 validation function, the application of the weighting to the number comprises multiplication of each digit of the number with the corresponding digit of the candidate weighting. This produces the weighted number (e.g. N1.W1, N2.W2 . . . N2.W8).

In step 6004, the sum of the weighted number is then calculated to determine a total for the weighted number. That is, each digit of the weighted number (being the digit of the number multiplied by the corresponding digit of the current candidate weighting) is added together (e.g. N1.W1+N1.W2 . . . +N8.W8).

For the modulus 10 validation function used in this example, the total of the weighted number is then divided by 10 in step 6006. This produces a single value for the number.

In step 6008 it is determined that if there is a remainder (that is, if the total of the weighted number does not divide exactly by 10) then the validation function confirms that the number, with that set of weightings, is not valid (step 6010). However, if in step 6008 it is determined that there is no remainder (that is, if the total of the weighted number divides exactly by 10) then the validation function confirms that the number, with that set of weightings, is valid (step 6012).

The outcome of the application of that candidate validation function to that number of the first set of numbers with that candidate weighting may then be recorded (e.g. does the validation function confirm that the number is valid or not valid). The above process is then repeated by the application unit 3004 for each validation function, with each candidate weighting for each number.

Now it will be appreciated that since the first data is valid data, any validation check (being the combination of the candidate validation function and candidate validation weighting) which does not produce the confirmation that the number is indeed valid is not the correct validation check for that number of the first data (i.e. it incorrectly asserts that the data is not valid). However, any validation check which produces confirmation that the number is valid is an appropriate validation check which could be used to validate that number in order to identify future inaccuracies in the data.

In other words, while a specific example of the application of the candidate validation function and candidate weightings to the number has been described with reference to FIG. 6 of the present disclosure, it will be appreciated that the present disclosure is not particularly limited in this respect. The steps 6000 to 6012 will vary depending on the type of validation function which is being applied to the data. Any conventional validation function can be used by the skilled person in accordance with embodiments of the disclosure.

It will be appreciated that, in certain examples, the application unit 3004 may be configured to apply the plurality of candidate validation functions and plurality of candidate weightings to the first data in sequence, and apply a subsequent candidate validation function and subsequent candidate weighting to the first data when the number of confirmations for a current candidate validation function and candidate weighting exceeds the predetermined threshold. That is, in the example of FIG. 6 of the present disclosure, once the current weighting and current validation function has been applied to the first number in the data, the same current weighing and current validation function are applied to the second number in the data. In fact, this same current weighting and current validation function are then applied to all numbers within first data in sequence.

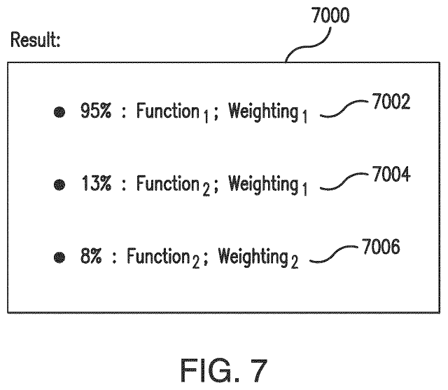

Alternatively, in certain examples, if the identification unit 3006 (described in more detail with reference to FIG. 7 of the present disclosure) identifies a certain validation check as a valid validation check for the first data (because at least a predetermined number of the numbers of the first data are correctly identified as valid using that validation check) then the application unit 3004 may proceed to the next candidate validation function and candidate weighting before the current candidate validation function and candidate weighing have been applied to all numbers of the first data (since the amount of numbers which pass using the current candidate validation function and candidate weighting have already reached the required predetermined threshold). This further improves the performance and efficiency of the apparatus 1000.

Furthermore, the circuitry is further configured to apply each of the plurality candidate validation functions and each of the plurality candidate weightings to the first data in parallel. For example, a distributed ledger may be used and web service APIs are used by participating nodes to see which number they should validate next (using which validation check). The results of the application of the candidate validation functions and the candidate weightings may then be published back to the ledger. In this distributed manner, the application of the candidate validation functions and candidate weightings to the first data can be performed in parallel, thus further improving the performance and efficiency of apparatus 1000. Optimised hardware (such as implementing the application unit 3004 as a plurality of graphical processing units) may further improve the computational performance of apparatus 1000 when identifying the validation check for the first set of numbers. This may be particularly advantageous where the computational effort is high due to the details of the situation to which the embodiments of the disclosure are applied.

### <Identification of the Validation Check>

As described with reference to FIG. 3 of the present disclosure, the identification unit 3006 may be configured to identify the validation check (being the validation function and weightings which should be applied to the first data in order to validate the first data) on the basis of the results from the application unit 3004.

It will be appreciated that the first data comprises a plurality of unique numbers (being the set of numbers obtained by the obtaining unit). For any given number of the set of numbers of the first number, there may be any number of validation checks (being a combination of validation function and weightings) which produces confirmation that the number is valid (including zero). In certain examples, it is likely that there will be one, or more than one, validation check of the plurality of candidate validation checks which produces confirmation that a given number is valid. However, it is likely that while certain validation checks produce valid confirmation for a first number of the set of numbers, the same certain validation check may not necessarily produce valid confirmation of a different number of the set of numbers. That is, a first set of weightings and first validation function may validate a first number of the set of numbers, but the same set of weightings and validation function may fail to validate a second number of the set of numbers.

It will be appreciated that having an individual validation check for each number is not a particularly computationally efficient situation, because a large number of individual validation functions and individual weightings would have to be stored and processed for the first data. Rather, it is computationally advantageous that an optimal validation function which provides confirmation for the first set of numbers as a whole is identified by apparatus 1000.

Accordingly, the identification unit is configured to identify the validation check for the set of numbers as a whole which produces valid confirmation of the set of numbers. That is, for example, if validation check A and B validate number 1, validation check A and C validate number 2 and validation check A and D validate number 3 (of a set comprising numbers 1, 2 and 3) then validation check A will be identified by the identification unit as the validation check to be used for that set of numbers.

An optimal solution would be to identify a validation check which can provide valid confirmation of 100% of the numbers in the set of numbers for which the validation check is unknown. However, in some situations, it may be the case that no optimal solution can be identified in this respect. In fact, in certain example situations to which embodiments of the disclosure can be applied, it may be sufficient that a solution is identified which can provide valid confirmation of a predetermined percentage of the numbers within the set of numbers (e.g. 90% of the numbers). Accordingly, the identification unit may, when the number of confirmations for a candidate weighting and a candidate validation function is above a predetermined threshold (corresponding to the predetermined percentage of numbers which need to pass using the validation check), be configured to identify the candidate validation function and the candidate weighting as the validation check for the first data.

In some situations, when the number of confirmations for a plurality of candidate weightings and candidate validation functions is above a predetermined threshold, the circuitry is configured to identify the candidate weighting and candidate validation with the highest number of confirmations as the validation check for the first data. That is, if validation check 1 (being validation function F1 and weightings W1) pass 92% of the numbers yet validation check 2 (being validation function F2 and weightings W2) pass 97% of the numbers (the predetermined threshold being 90% of the numbers) then identification unit 3006 will identify validation check 1 as the validation check to use for the first set of numbers.

An output of the apparatus for identifying a validation check for a set of numbers in accordance with embodiments of the disclosure is illustrated in FIG. 7. That is, FIG. 7 shows an output 7000 of the results of the application unit 3004, which is processed by identification unit 3006. In this specific example, 95% of the numbers were passed with validation function 1 and weighting 1 (as shown in 7002), 13% of the numbers were passed with validation function 2 and weighting 1 (as shown in 7004) and 8% of the numbers were passed with validation function 2 and weighting 2 (as shown in 7006). In this specific example, the identification unit 3006 may be configured to select validation function 1 and weighting 1 as the validation check for the first set of numbers. In some situations, the output may be displayed on an output unit (such as display device 1010), where it can be monitored by an expert operator. In other situations, the output may be passed directly to identification unit 3006 for processing without any visual display.

The present disclosure is not particularly limited to these examples of identifying the validation check for the first set of numbers based on the result of the application of the candidate validation functions and validation weightings to the set of numbers of the first data. However, it will be appreciated that, based on these results, apparatus 1000 can identify an appropriate validation check for the first set of data.

### <Advantageous Technical Effects>

Accordingly, apparatus 1000 is configured to identify a validation check (being a validation function and corresponding weighting) for the first set of data. Advantageously, this validation check can then be used to validate the numbers of the first set of data (at a later stage of processing, for example) to identify any inaccuracies which inadvertently enter into the first set of data (such as a data entry mistake, transposition, or the like). This means that the data of the first data (for which the validation check was previously unknown) is no longer unusable, and may be maintained. Expensive and disruptive actions to generate new data (to replace the data for which the validation check is unknown) no longer need to be taken.

In fact, the aforementioned configuration of apparatus 1000 (as described with reference to FIGS. 3 to 6 of the present disclosure) provides a particularly efficient and reliable mechanism for identifying the appropriate validation check for a set of numbers, reducing the computational burden numbers for which a validation check is not available have upon the computational system.

### <Modifications>

While certain features of the present disclosure have been described with reference to FIGS. 4 to 7 of the present disclosure, it will be appreciated that the present disclosure is not particularly limited in this regard. For example, the following additional modifications to the aforementioned process (described with reference to FIGS. 4 to 7 of the present disclosure) may be made in accordance with embodiments of the disclosure.

### <Second Data>

In some example situations, an optimal solution passing 100% of the numbers of the first data may be identified by the identification unit 3006 following the application of the candidate validation functions and the candidate weightings to the first data by application unit 3004. However, as noted with reference to FIG. 7 of the present disclosure, there may be situations whereby the best validation check which has been found passes only a certain percentage (such as 95%) of the numbers of the first data.

In some situations, the numbers of the first data for which the validation check identified by the identification unit 3006 does not produce confirmation (e.g. the 5% of numbers of the first data in this specific example) may be marked as numbers for which the validation check could not be identified. These numbers may then be identified as numbers which can no longer be maintained (as it will not be possible to apply a validation check to these numbers to identify any inaccuracies which subsequently anse in the data). Remedial action may therefore have to be taken with respect to these numbers of the first data. However, since this number is significantly less than the total amount of numbers in the first data, the computational burden numbers for which, initially, a validation check is not available have upon the computational system is still reduced. Additionally, in the example of financial institutions or the like, the business costs related to closing the accounts associated with the numbers of the first data are significantly reduced, as remedial action needs to be taken with respect to only a small subset of those accounts (being the accounts associated with the numbers for which the validation check could not be identified) versus all of the accounts.

In certain examples, it may be that the best validation check which has been identified fro the first data has a value which is below the predetermined threshold value (e.g. the threshold value is 90%, but the best validation check which has been identified passes only 75% of the numbers). In this situation, further actions may be taken by apparatus 1000 in response to this determination. In certain situations, the range of candidate validation checks and/or candidate weightings may be expanded such that a more appropriate validation check can be identified (with the aim of identifying a validation check which can pass a higher percentage of the numbers of the first data). However, in certain examples, an evaluation of the situation may be taken in order to determine whether or not to use the validation check for the first data even if that best validation check does not pass the predetermined threshold amount of numbers of the first data. This evaluation of the situation may include factors such as the costs (including computational resources) of implementing further modulus checks against the first data versus the associated costs of the remedial action for the sub-section of numbers for which the validation check which has been identified does not produce validity confirmation.

Furthermore, in certain example situations, it may be advantageous to consider the subset of numbers of the first data for which the validation check does not produce valid confirmation (e.g. the 5% of numbers of the first data in this specific example) as a second data set, such that a second validation check applicable only to the second data set can be determined.

As such, according to certain examples, apparatus 1000 may further be configured to obtain second data, the second data comprising a subset of numbers of the first data for which the validation check for the first data did not confirm that the number is valid; for each of the plurality candidate validation functions and each of the plurality candidate weightings: apply the candidate validation function to first data using the set of unique numbers and the candidate weighting as input; and determine, for each number of the set of unique numbers, whether the candidate validation function confirms that the number is valid using the candidate weighting; and when, for the second data, the number of confirmations for a candidate weighting and a candidate function is above a predetermined threshold, identify the candidate validation function and the candidate weighting as a second validation check for the second data. In this manner, a validation check for the second set of numbers (being a validation check which passes a significant percentage of the second set of numbers) may be identified in addition to the first validation check for the first data. This enables those numbers of the second set of numbers for which the second validation check produces confirmation that the number is valid to be maintained in addition to those numbers of the first data for which the first validation check has been obtained.

In fact, in certain examples, identification unit 3006 of apparatus 1000 may be configured to identify the candidate weightings and candidate validation functions as the validation check for the first data and second data respectively which, in combination, have the highest number of confirmations wherein when the number of confirmations for a plurality of candidate weightings and candidate validations functions is above a predetermined threshold, as the validation check for the first data and second data respectively which, in combination, have the highest number of confirmations.

Consider an example whereby a first validation check A passes 90% of the first data and a second validation check A1 passes a further 90% of the second data (being a subset comprising the 10% of the numbers of the first data which validation check A does not pass). In addition, a third validation check B passes 92% of the first data and a fourth validation check B1 passes a further 30% of the second data (being a subset comprising the 8% of the numbers of the first data which validation check B does not pass). Finally, it is noted that the first validation check A passes 90% of the first data, while fourth validation check B1 (in combination with the numbers which have not been passed with validation check A) passes only 3% of the second data (being the subset comprising the 10% of numbers not passes by validation check A).

For an example first data set comprising 1000 numbers, validation checks A and A1 pass a total number of 990 numbers of the first data in combination (A passes 900 numbers of the first data, and A1 passes 90 of the remaining 100 numbers (forming the second data)). In contrast, validation checks B and B1 pass a total of 944 numbers of the first data in combination (B passes 920 numbers of the first data, and B1 passes 24 of the remaining 80 numbers (forming the second data)). Finally, the combination of validation check A and B1 passes only a total of 903 of the numbers (A passes 900 numbers of the first data, and B1 passes 3 of the remaining 100 numbers (forming the second data)).

As such, even though individually validation check B passes a higher number percentage of the numbers of the first data set, the combination of the validation check A and A1 results in the highest total number of confirmations. Validation checks A and A1 are thus identified by the identification unit 3006 as the first and second validation check respectively.

Obtaining a second data, being a subset of the first data for which the selected validation check does not produce confirmation that the number is valid, in this manner further reduces the impact which the numbers which, initially, information regarding the validation check is not available have upon the computational system. In fact, even in the event that no optimal solution can be found this burden is reduced, because remedial action is limited to only a small subset of the numbers for which neither the first nor the second validation check provide validation confirmation.

### <Test Data>

Even if a validation check passes a high percentage of the numbers of the first data, it may be that the validation check would pass almost any number (even if that number was not per se a valid number). As such, even though the validation check produces a high number of confirmations for the first set of data, there may be a situation whereby it is less effective at identifying inaccuracies which arise in the data at a later stage (with even the inaccuracies in the data being passed as valid numbers). Accordingly, in certain situations, it may be advantageous to limit the number of false positives which the validation check chosen for the first data set produces.

As such, optionally, apparatus 1000 may further be configured to obtain a set of test data, the test data comprising a set of unique random numbers, each number of the set of unique numbers being a multi-digit number having the predetermined length; and for each of the plurality candidate validation functions and each of the plurality candidate weightings: apply the candidate validation function to test data using the set of unique random numbers and the candidate weighting as input; and determine, for each number of the set of unique set of random numbers, whether the candidate validation function confirms that the number is valid using the candidate weighting.

The random test data may be generated by any means (such as a random number generator or the like). There may be a single set of random data to be used on numerous sets of data or, alternatively, the random test data may be generated by apparatus 1000 uniquely and individually for each data set. Advantageously, the first set of numbers should be the same format and type of the first data itself. That is, if the first data (for which the validation check is unknown) comprises multi-digit numbers of a certain length (such as eight digits) then the test data should also be of the same length as the first data (e.g. eight digits in length). This ensures that the test data is compatible with the candidate validation functions and candidate weightings which have been determined for the first data by the determining unit 3002.

However, unlike the first data (which is valid, but for which the validation check is unknown) the test data is, itself, not valid (being random numbers which have not been generated by a validation function with candidate weightings). Accordingly, the candidate validation functions and candidate weightings should not identify the test data as valid. That is, the validation check which passes the first data should not pass a significant number of the numbers in the test data.

As such, in certain examples, the identification unit 3006 of apparatus 1000 may be configured to identify a candidate weighting and a candidate validation function (i.e. a validation check) based on a result of the application of the candidate validation functions and weightings to the first data. Specifically, a validation check for which the number of confirmations for the test data is above a predetermined threshold is excluded from identification as the validation check for the first data.

The optimal solution could be considered to be a validation check which passes 100% of the first data and passes 0% of the random test data. However, in a number of example situations, it may be sufficient that a validation check for the first data passes a given percentage of the numbers of the first data (e.g. 90% (corresponding to a low rate of false negatives)) and passes a percentage of the random test data which is below a given threshold percentage (e.g. 10% (corresponding to a low rate of false positives)). These levels may vary in accordance with the demands of the system.

Consider an example whereby a first validation check A passes 95% of the first data and passes 5% of the random test data, a second validation check B passes 96% of the first data and passes 72% of the random test data and a third validation check C passes 30% of the first data and passes 2% of the random test data. In this example situation, even though validation check B passes a higher percentage of the first data than validation check A, validation check B also passes a significantly higher amount of the random test data than validation check A. This means that inaccuracies subsequently introduced into the first data may go undetected by validation check B. Accordingly, in this situation, validation check A should be identified by identification unit 3006 as the appropriate validation check for the first data.

As such, the use of test data by apparatus 1000 improves the identification of the validation check for the first data by ensuring that the validation check which is selected for the first data has a low rate of false positive validity confirmations. This further reduces the computational burden numbers for which a validation check is, initially, not available have upon the computational system.

### <Method>

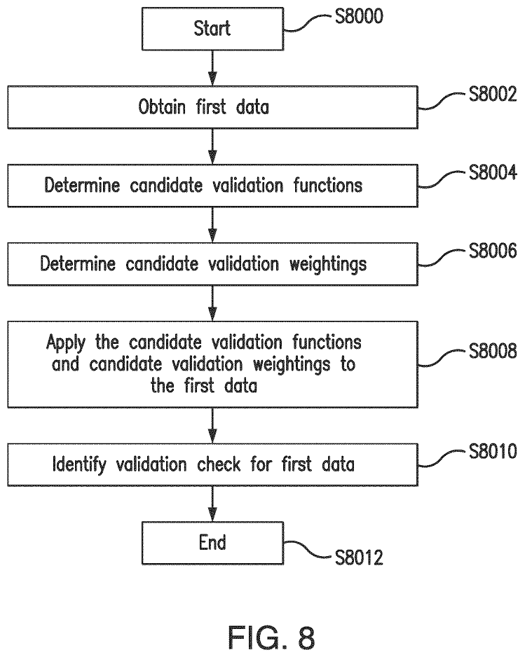

FIG. 8 illustrates a method of identifying a validation check for a set of numbers in accordance with embodiments of the disclosure. The method may be applied or performed by an apparatus such as apparatus 1000 described with reference to FIG. 1 of the present disclosure.

The method begins with step S8000 and proceeds to step S8002.

In step S8002, the method comprises obtaining first data, the first data comprising a set of unique numbers for which a validation check is unknown, each number of the set of unique numbers being a multi-digit number having a predetermined length.

Once the first data has been obtained, the method proceeds to step S8004.

In step S8004, the method comprises determining a plurality of candidate validation functions to apply to the first data, each of the plurality of candidate validation functions being configured to take a number and weighting as input to the function and return, on the basis of the input, confirmation of whether the number is valid.

Once the candidate validation functions have been determined, the method proceeds to step S8006.

In step S8006, the method comprises determining a plurality of candidate weightings to apply to the first data.

Once the plurality of candidate weightings have been determined, the method proceeds to step S8008.

In step S8008, the method comprises applying, for each of the plurality candidate validation functions and each of the plurality candidate weightings, the candidate validation function to first data using the set of unique numbers and the candidate weighting as input and determining, for each number of the set of unique numbers, whether the candidate validation function confirms that the number is valid using the candidate weighting.

The method proceeds to step S8010.

In step S8010, the method comprises identifying a candidate validation function and a candidate weighting as the validation check for the first data when, for the first data, the number of confirmations for the candidate weighting and the candidate validation function is above a predetermined threshold.

The method then proceeds to, and ends with, step S8012.

It will be appreciated that the method of identifying a validation check for a set of numbers according to embodiments of the disclosure is not limited to the method steps illustrated in FIG. 8 of the disclosure. For example, according to embodiments of the disclosure, certain steps of the method of identifying a validation check for a set of numbers may be applied or performed in parallel.

Optionally, the method may further comprise returning to step S8008 and applying the candidate validation functions and candidate validation weightings to a second set of numbers, such as a subset of the first data of numbers (being numbers of the first data for which the validation check for the first data does not return valid confirmation). This enables a second validation check for the second set of numbers to be determined.

### Example Implementation

Embodiments of the disclosure may be applied to an example situation where a financial institution wishes to validate a set of account numbers and sort codes, but where the information regarding the validation check for those accounts is unknown. It will be appreciated that the present disclosure is not limited to this specific example situation.

Initially, a list of account numbers and, optionally, sort codes for which a set of modulus weightings and a suitable algorithm (or function) is created. A separate list of random test data is also loaded at the same time.

For each sorting code, these numbers are loaded into memory as a logical array.

A set of candidate weightings is established using a logical FOR-NEXT lop which, in some situations, runs from 00000000 to 99999999 (a UK account number has 8 digits, each of which is assigned a weighting). In this example, one or more digits are known to be a check digit, and so the counter runs from 0000000 to 9999999, or 000000 to 999999 where two digits are used for check digits. A configuration file may be used to specify the start and end number range; and also to fix specific digits to specific values (including the position of the check digit). Reducing the range of candidate weightings further improves the computational efficiency. Furthermore, in certain examples, a pattern may be used in order to indicate which digits within the candidate numbers may be varied. 12XX00XX would indicate that only four numbers are to be used in the loop. Reducing the number of candidate weightings in this manner further improves the computational efficiency. The financial institution may set the range and/or pattern of candidate weightings as a first attempt if they are aware of certain precedents which indicate that the solution must be in those ranges.

All of the applicable modulus functions (being the candidate functions which have been selected) for that set of numbers are then applied to each account number in the array using the current value of the FOR-NEXT counter (i.e. the current weighting in the range of candidate weightings).

The total number of account numbers that pass for a given set of weightings may be recorded, along with the total number of passes from the test data set. A threshold value is stored in a configuration file stating the minimum acceptable number of passes and the acceptable false positive rate. In certain examples, a financial institution may seek that the weightings match at least 90% of the account numbers and reject 50% of the test data values (the optimal being 100% pass of accounts and 90% of test data being rejected). Of course, the present disclosure is not particularly limited to these specific example thresholds. If the threshold value is passed before the check is finished exhaustively check it can be abandoned and the next weighting set started. This further improves computational efficiency of the system.

Output from the determination of the validation check may indicate the candidate weightings and modulus functions which achieved the predetermined thresholds.

Having completed the first pass and come to the conclusion that no optimal solution is available for the account numbers, a second set of numbers (being the subset of numbers of the list of accounts which did not pass on the first attempt) may be produced. The above process of determining the validation check may then be applied to the second set of numbers (optionally with increased range of candidate numbers). This enables a validation check which addresses the remaining account numbers (being those account numbers which failed the first pass).

In this manner, a first validation check (which matches at least 90% of the account numbers) and a second validation check (which matches 95% of the remaining account numbers) may be identified. In certain examples, a validation check may be unavailable for the remaining 5% of the second set of numbers. However, a flag/alert may be created for those reaming 5% of the second set of numbers. Additional remedial action may then only be required for the remaining 5% of the second set of numbers. All the other accounts, being those accounts for which a solution was found in the first or second attempt may then continue to be used by the financial institutions, since a validation check for those accounts has been identified. This reduces the impact accounts which have no validation check have upon the computational systems of the financial institutions.

### Other Example Implementations

While embodiments of the disclosure have been described with reference to their potential implementation to a set of numbers comprising a set of bank account numbers and/or sort codes, it will be appreciated that the present disclosure is not particularly limited this regard. In particular, embodiments of the disclosure may be applied to any such situation whereby a set of unique multi-digit numbers is obtained, and a validation check is sought for those numbers (the original information regarding the validation checks being unavailable).

In fact, embodiments of the disclosure may be particularly advantageous in the identification of validation checks for any data comprising numbers which include a check digit or the like including data such as international standard book numbers, patent application numbers, numbers of registered users of a health service or the like. In each of these situations, a validation check (including a weighting and a validation function (such as the modulus/modulo 10 algorithm)) can be identified for the data using the apparatus, method and computer program product of the present disclosure. This validation check can then be used in order to identify subsequent inaccuracies in the data as they arise.

Accordingly, embodiments of the present disclosure provide a particularly efficient and reliable mechanism for identifying the validation check for a set of numbers, further reducing the computational burden numbers for which a validation check is not available have upon the computational system.

### CLAUSES

Furthermore, certain embodiments of the disclosure may be arranged in accordance with the following numbered clauses:

1. An apparatus for identifying a validation check for a set of numbers, the apparatus comprising circuitry configured to:
obtain first data, the first data comprising a set of unique numbers for which a validation check is unknown, each number of the set of unique numbers being a multi-digit number having a predetermined length;
determine a plurality of candidate validation functions to apply to the first data, each of the plurality of candidate validation functions being configured to take a number and weighting as input to the function and return, on the basis of the input, confirmation of whether the number is valid;
determine a plurality of candidate weightings to apply to the first data; and
for each of the plurality candidate validation functions and each of the plurality candidate weightings:
   apply the candidate validation function to first data using the set of unique numbers and the candidate weighting as input; and
   determine, for each number of the set of unique numbers, whether the candidate validation function confirms that the number is valid using the candidate weighting;
and when, for the first data, the number of confirmations for a candidate weighting and a candidate validation function is above a predetermined threshold, identify the candidate validation function and the candidate weighting as the validation check for the first data.
   2. The apparatus according to Clause 1, wherein the circuitry is further configured to obtain second data, the second data comprising a subset of numbers of the first data for which the validation check for the first data did not confirm that the number is valid;
for each of the plurality candidate validation functions and each of the plurality candidate weightings:
apply the candidate validation function to first data using the set of unique numbers and the candidate weighting as input; and
determine, for each number of the set of unique numbers, whether the candidate validation function confirms that the number is valid using the candidate weighting;
and when, for the second data, the number of confirmations for a candidate weighting and a candidate function is above a predetermined threshold, identify the candidate validation function and the candidate weighting as a second validation check for the second data.
   3. The apparatus according to any preceding Clause, wherein the apparatus is configured to determine a plurality of candidate validation functions from a list including at least a standard modulus function and a double alternative modulus function.
   4. The apparatus according any preceding Clause, wherein the set of unique numbers is a set of account numbers.
   5. The apparatus according to any of Clauses 1, 2 or 3, wherein the set of unique numbers is a set of account numbers and sort codes.
   6. The apparatus according to any preceding Clause, wherein the circuitry is further configured to determine the plurality of candidate weightings to apply to the first data by setting a range of candidate weightings between a predetermined start and end number.
   7. The apparatus according to any preceding Clause, wherein each candidate weighting is a multi-digit number having the predetermined length, and wherein the circuitry is configured to vary only digits in a predetermined location within each multi-digit candidate weighting when determining candidate weightings to apply to the first data.
   8. The apparatus according to any preceding Clause, wherein when the number of confirmations for a plurality of candidate weightings and candidate validation functions is above a predetermined threshold, the circuitry is configured to identify the candidate weighting and candidate validation with the highest number of confirmations as the validation check for the first data.
   9. The apparatus according to Clause 2, wherein when the number of confirmations for a plurality of candidate weightings and candidate validations functions is above a predetermined threshold, the circuitry is configured to identify the candidate weightings and candidate validation functions as the validation check for the first data and second data respectively which, in combination, have the highest number of confirmations.
   10. The apparatus according to any preceding Clause, wherein the circuitry is configured to apply the plurality of candidate validation functions and plurality of candidate weightings to the first data in sequence, and wherein the circuitry is configured proceed to applying a subsequent candidate validation function and subsequent candidate weighting to the first data when the number of confirmations for a current candidate validation function and candidate weighting exceeds the predetermined threshold.
   11. The apparatus according to any preceding Clause, wherein the apparatus is further configured to obtain test data, the test data comprising a set of unique random numbers, each number of the set of unique numbers being a multi-digit number having the predetermined length; and
for each of the plurality candidate validation functions and each of the plurality candidate weightings:
apply the candidate validation function to test data using the set of unique random numbers and the candidate weighting as input; and
determine, for each number of the set of unique set of random numbers, whether the candidate validation function confirms that the number is valid using the candidate weighting;
wherein a candidate weighting and a candidate validation function which for which the number of confirmations for the test data is above a predetermined threshold is excluded from identification as the validation check for the first data.
   12. The apparatus according to any of Clauses 1 to 10, wherein the circuitry is further configured to apply each of the plurality candidate validation functions and each of the plurality candidate weightings to the first data in parallel.
   13. The apparatus according to any preceding Clause, wherein the candidate validation functions and/or the plurality of candidate weightings are a subset of a list of available validation functions and/or weightings, and wherein the circuitry is further configured to expand the determination of the candidate validation functions and/or the plurality of candidate weightings to encompass the available validation functions and/or weightings when a validation check for the first data meeting the predetermined threshold is not found.
   14. A method of identifying a validation check for a set of numbers, the method comprising the steps of:
obtaining first data, the first data comprising a set of unique numbers for which a validation check is unknown, each number of the set of unique numbers being a multi-digit number having a predetermined length;
determining a plurality of candidate validation functions to apply to the first data, each of the plurality of candidate validation functions being configured to take a number and weighting as input to the function and return, on the basis of the input, confirmation of whether the number is valid;
determining a plurality of candidate weightings to apply to the first data; and
for each of the plurality candidate validation functions and each of the plurality candidate weightings:
   applying the candidate validation function to first data using the set of unique numbers and the candidate weighting as input; and
   determining, for each number of the set of unique numbers, whether the candidate validation function confirms that the number is valid using the candidate weighting;
and when, for the first data, the number of confirmations for a candidate weighting and a candidate validation function is above a predetermined threshold, identifying the candidate validation function and the candidate weighting as the validation check for the first data.
   15. A computer program product comprising instructions which, when the instructions are implemented by a computer, cause the computer to perform a method of identifying a validation check for a set of numbers, the method comprising the steps of
obtaining first data, the first data comprising a set of unique numbers for which a validation check is unknown, each number of the set of unique numbers being a multi-digit number having a predetermined length;
determining a plurality of candidate validation functions to apply to the first data, each of the plurality of candidate validation functions being configured to take a number and weighting as input to the function and return, on the basis of the input, confirmation of whether the number is valid;
determining a plurality of candidate weightings to apply to the first data; and
for each of the plurality candidate validation functions and each of the plurality candidate weightings:
   applying the candidate validation function to first data using the set of unique numbers and the candidate weighting as input; and
   determining, for each number of the set of unique numbers, whether the candidate validation function confirms that the number is valid using the candidate weighting;
and when, for the first data, the number of confirmations for a candidate weighting and a candidate validation function is above a predetermined threshold, identifying the candidate validation function and the candidate weighting as the validation check for the first data.

Obviously, numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

What is claimed is:

1. An apparatus for identifying a validation check for a set of numbers, the apparatus comprising circuitry configured to:
obtain first data, the first data comprising a set of unique numbers for which a validation check is unknown, each number of the set of unique numbers being a multi-digit number having a predetermined length;
determine a plurality of candidate validation functions to apply to the first data, each of the plurality of candidate validation functions being configured to take a number and weighting as input to the function and return, on the basis of the input, confirmation of whether the number is valid;
determine a plurality of candidate weightings to apply to the first data;
for each of the plurality of candidate validation functions and each of the plurality of candidate weightings:
apply the candidate validation function to the first data using the set of unique numbers and the candidate weighting as input; and
determine, for each number of the set of unique numbers, whether the candidate validation function confirms that the number is valid using the candidate weighting;
and when, for the first data, the number of confirmations for a candidate weighting and a candidate validation function is above a predetermined threshold, identify the candidate validation function and the candidate weighting as the validation check for the first data.

2. The apparatus according to claim 1, wherein the circuitry is further configured to obtain second data, the second data comprising a subset of numbers of the first data for which the validation check for the first data did not confirm that the number is valid;
for each of the plurality of candidate validation functions and each of the plurality of candidate weightings:
apply the candidate validation function to the first data using the set of unique numbers and the candidate weighting as input; and
determine, for each number of the set of unique numbers, whether the candidate validation function confirms that the number is valid using the candidate weighting;
and when, for the second data, the number of confirmations for a candidate weighting and a candidate function is above a predetermined threshold, identify the candidate validation function and the candidate weighting as a second validation check for the second data.

3. The apparatus according to claim 1, wherein the apparatus is configured to determine a plurality of candidate validation functions from a list including at least a standard modulus function and a double alternative modulus function.

4. The apparatus according to claim 1, wherein the set of unique numbers is a set of account numbers.

5. The apparatus according to claim 1, wherein the set of unique numbers is a set of account numbers and sort codes.

6. The apparatus according to claim 1, wherein the circuitry is further configured to determine the plurality of candidate weightings to apply to the first data by setting a range of candidate weightings between a predetermined start and end number.

7. The apparatus according to claim 1, wherein each candidate weighting is a multi-digit number having the predetermined length, and wherein the circuitry is configured to vary only digits in a predetermined location within each multi-digit candidate weighting when determining candidate weightings to apply to the first data.

8. The apparatus according to claim 1, wherein when the number of confirmations for a plurality of candidate weightings and candidate validation functions is above a predetermined threshold, the circuitry is configured to identify the candidate weighting and candidate validation with the highest number of confirmations as the validation check for the first data.

9. The apparatus according to claim 2, wherein when the number of confirmations for a plurality of candidate weightings and candidate validations functions is above a predetermined threshold, the circuitry is configured to identify the candidate weightings and candidate validation functions as the validation check for the first data and second data respectively which, in combination, have the highest number of confirmations.

10. The apparatus according to claim 1, wherein the circuitry is configured to apply the plurality of candidate validation functions and plurality of candidate weightings to the first data in sequence, and wherein the circuitry is configured to proceed to apply a subsequent candidate validation function and subsequent candidate weighting to the first data when the number of confirmations for a current candidate validation function and candidate weighting exceeds the predetermined threshold.

11. The apparatus according to claim 1, wherein the apparatus is further configured to obtain test data, the test data comprising a set of unique random numbers, each number of the set of unique random numbers being a multi-digit number having the predetermined length; and
for each of the plurality candidate validation functions and each of the plurality candidate weightings:
apply the candidate validation function to the test data using the set of unique random numbers and the candidate weighting as input; and
determine, for each number of the set of unique random numbers, whether the candidate validation function confirms that the number is valid using the candidate weighting;
wherein a candidate weighting and a candidate validation function for which the number of confirmations for the test data is above a predetermined threshold is excluded from identification as the validation check for the first data.

12. The apparatus according to claim 1, wherein the circuitry is further configured to apply each of the plurality candidate validation functions and each of the plurality candidate weightings to the first data in parallel.

13. The apparatus according to claim 1, wherein the candidate validation functions and/or the plurality of candidate weightings are a subset of a list of available validation functions and/or weightings, and wherein the circuitry is further configured to expand the determination of the candidate validation functions and/or the plurality of candidate weightings to encompass the available validation functions and/or weightings when a validation check for the first data meeting the predetermined threshold is not found.

14. A method of identifying a validation check for a set of numbers, the method comprising the steps of:
obtaining first data, the first data comprising a set of unique numbers for which a validation check is unknown, each number of the set of unique numbers being a multi-digit number having a predetermined length;
determining a plurality of candidate validation functions to apply to the first data, each of the plurality of candidate validation functions being configured to take a number and weighting as input to the function and return, on the basis of the input, confirmation of whether the number is valid;
determining a plurality of candidate weightings to apply to the first data;
for each of the plurality of candidate validation functions and each of the plurality of candidate weightings:
applying the candidate validation function to the first data using the set of unique numbers and the candidate weighting as input; and
determining, for each number of the set of unique numbers, whether the candidate validation function confirms that the number is valid using the candidate weighting;
and when, for the first data, the number of confirmations for a candidate weighting and a candidate validation function is above a predetermined threshold, identifying the candidate validation function and the candidate weighting as the validation check for the first data.

15. A non-transitory computer program product comprising instructions which, when the instructions are implemented by a computer, cause the computer to perform a method of identifying a validation check for a set of numbers, the method comprising the steps of:
obtaining first data, the first data comprising a set of unique numbers for which a validation check is unknown, each number of the set of unique numbers being a multi-digit number having a predetermined length;
determining a plurality of candidate validation functions to apply to the first data, each of the plurality of candidate validation functions being configured to take a number and weighting as input to the function and return, on the basis of the input, confirmation of whether the number is valid;
determining a plurality of candidate weightings to apply to the first data;
for each of the plurality of candidate validation functions and each of the plurality of candidate weightings:
applying the candidate validation function to the first data using the set of unique numbers and the candidate weighting as input; and
determining, for each number of the set of unique numbers, whether the candidate validation function confirms that the number is valid using the candidate weighting;
and when, for the first data, the number of confirmations for a candidate weighting and a candidate validation function is above a predetermined threshold, identifying the candidate validation function and the candidate weighting as the validation check for the first data.
